(19) United States
(12) Patent Application Publication
(10) Pub. No.: US 2026/0019112 A1
(43) Pub. Date: Jan. 15, 2026

(54) RFIC, MMU APPARATUS INCLUDING RFIC, AND OPERATING METHOD THEREOF

(71) Applicant: Samsung Electronics Co., Ltd., Suwon-si (KR)

(72) Inventors: Jangwon PARK, Suwon-si (KR); Jaijin LIM, Suwon-si (KR); Seungyoup HAN, Suwon-si (KR)

(21) Appl. No.: 19/327,469

(22) Filed: Sep. 12, 2025

Related U.S. Application Data
(63) Continuation of application No. PCT/KR2024/002780, filed on Mar. 5, 2024.

(30) Foreign Application Priority Data
Mar. 13, 2023 (KR) 10-2023-0032866
Apr. 26, 2023 (KR) 10-2023-0054923

(51) Int. Cl. H04B 7/0413; H04B 1/40; H04L 27/26

(52) U.S. Cl. CPC H04B 7/0413; H04B 1/40; H04L 27/2634

(57) ABSTRACT

A radio frequency integrated circuit (RFIC), a massive multiple-input multiple-output (MIMO) unit (MMU) apparatus including the RFIC, and an operating method are provided. The RFIC includes a digital front end unit configured to up-convert a transmitting signal and down-convert a receiving signal, a fast Fourier transform (FFT)/inverse FFT (iFFT) unit configured to convert the transmitting signal from a frequency domain to a time domain and convert the receiving signal from a time domain to a frequency domain, a cyclic prefix (CP) unit configured to add CP to the transmission signal and remove CP from the reception signal, and an interface unit configured to communicate with a signal processing unit.

### CROSS-REFERENCE TO RELATED APPLICATION(S)

This application is a continuation application, claiming priority under 35 U.S.C. § 365 (c), of an International application No. PCT/KR2024/002780, filed on Mar. 5, 2024, which is based on and claims the benefit of a Korean patent application number 10-2023-0032866, filed on Mar. 13, 2023, in the Korean Intellectual Property Office, and of a Korean patent application number 10-2023-0054923, filed on Apr. 26, 2023, in the Korean Intellectual Property Office, the disclosure of each of which is incorporated by reference herein in its entirety.

### BACKGROUND

### 1. Field

The disclosure relates to a radio frequency integrated circuit (RFIC), a massive multiple-input multiple-output (MIMO) unit (MMU) device including an RFIC, and a method for operating the same.

### 2. Description of Related Art

5th-generation (5G) mobile communication technologies define broad frequency bands to enable high transmission rates and new services, and can be implemented not only in “Sub 6 GHz” bands such as 3.5 GHz, but also in “Above 6 GHz” bands referred to as millimeter wave (mmWave) including 28 GHz and 39 GHz.

The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In the related art, base stations for providing wireless communication services have been installed at cell sites such that the data processing unit or digital unit (or distributed unit) (DU) and the radio transceiver or radio unit (or remote unit) (RU) of the base stations are integrated with each other. Such conventional base stations were not suitable for constructing multiple cell sites to accommodate increasing users and traffic. To address this, a base station structure has been developed wherein the DUs are located at a single physical site in a concentrated manner, and only the RUs remain at the cell sites at which radio signals are actually transmitted/received with user equipment (UEs). In this structure, the DUs and RUs may be connected through optical cables or coaxial cables. The 3rd Generation Partnership Project (3GPP) has standardized such as base station architecture, and the Open Radio Access Network (O-RAN), an open network standard applicable to 5G systems, is being researched.

In such a base station structure where the DUs and RUs are separated, radio frequency (RF) signals are received through the RUs and massive MIMO unit (MMU) devices. To achieve high data transmission rates, there is a need for an RFIC having a new structure and an MMU device including the RFIC structure.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a radio frequency integrated circuit (RFIC), a massive multiple-input multiple-output (MIMO) unit (MMU) device including an RFIC, and a method for operating the same.

Additional aspects will be set forth in part in the description which follows and, in part, will be apparent from the description, or may be learned by practice of the presented embodiments.

In accordance with an aspect of the disclosure, a radio frequency integrated circuit (RFIC) is provided. The RFIC includes a digital front end unit configured to up-convert a transmission signal and down-convert a reception signal, a fast Fourier transform (FFT)/inverse FFT (iFFT) unit configured to convert the transmission signal from a frequency domain to a time domain and convert the reception signal from a time domain to a frequency domain, a CP unit configured to add a cyclic prefix (CP) to the transmission signal and remove a CP from the reception signal, and an interface unit configured to perform communication with a signal processing unit.

In an embodiment, the interface unit includes an optical input/output (I/O) device.

In an embodiment, the optical I/O device includes a photonic integrated chip (PIC), and the interface unit further includes an electronic integrated circuit (EIC) for driving the PIC and a framer configured to convert a processed signal into a form that can be transmitted at the PIC and convert a signal received at the PIC into a processable form.

In an embodiment, the interface unit includes a serializer-deserializer (SerDes).

In an embodiment, the interface unit includes a framer configured to convert a processed signal into a form that can be transmitted at an interface and convert a signal received at the interface into a processable form.

In an embodiment, the signal processing unit processes a digital signal according to a low-physical (PHY) layer function and performs beamforming.

In an embodiment, the signal processing unit includes a digital application specific integrated circuit (ASIC).

In accordance with another aspect of the disclosure, a massive multiple-input multiple-output (MIMO) unit (MMU) device is provided. The MMU device includes at least one antenna and at least one radio frequency integrated circuit (RFIC) connected to the at least one antenna, wherein the at least one RFIC includes a digital front end unit configured to up-convert a transmission signal and down-convert a reception signal, a fast Fourier transform (FFT)/inverse FFT (iFFT) unit configured to convert the transmission signal from a frequency domain to a time domain and convert the reception signal from a time domain to a frequency domain, a CP unit configured to add a cyclic prefix (CP) to the transmission signal and remove a CP from the reception signal, and an interface unit configured to communicate with a signal processing unit.

In an embodiment, the interface unit includes an optical input/output (I/O) device.

In an embodiment, the optical I/O device includes a photonic integrated chip (PIC), and the interface unit further includes an electronic integrated circuit (EIC) for driving the PIC and a framer configured to convert a processed signal into a form that can be transmitted at the PIC and convert a signal received at the PIC into a processable form.

In an embodiment, the interface unit includes a serializer-deserializer (SerDes).

In an embodiment, the interface unit includes a framer configured to convert a processed signal into a form that is transmitted at an interface and convert a signal received at the interface into a processable form.

In an embodiment, the signal processing unit processes a digital signal according to a low-physical (PHY) layer function and performs beamforming.

In an embodiment, the signal processing unit includes a digital application specific integrated circuit (ASIC).

In accordance with another aspect of the disclosure, a method for operating a radio frequency integrated circuit (RFIC) is provided. The method includes amplifying a signal received from at least one antenna at an analog front end unit, converting the amplified signal to a digital signal at an analog-to-digital conversion (ADC) unit, down-converting the digital signal at a digital front end unit, converting the down-converted signal from a time domain to a frequency domain at a fast Fourier transform (FFT) unit, removing a cyclic prefix (CP) from the signal converted to the frequency domain at a CP unit, converting the signal from which the CP has been removed into a form that is capable of being transmitted at a photonic integrated chip (PIC) at a framer, and transferring the converted signal to a signal processing unit at the PIC.

In an embodiment, the method for operating an RFIC further includes a step of receiving a signal from the signal processing unit at the PIC, a step of converting the received signal into a processable form at the framer, a step of adding a CP to the converted signal at the CP unit, a step of converting the signal having the added CP from a frequency domain to a time domain at an inverse FFT (iFFT) unit, a step of up-converting the time domain signal at a digital front end unit, a step of converting the up-converted signal to an analog signal at a digital-to-analog conversion (DAC) unit, and a step of amplifying the analog signal at an analog front end unit and transferring the same to the at least one or more antennas.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include amplifying a signal received from at least one antenna at an analog front end unit, converting the amplified signal to a digital signal at an analog-to-digital conversion (ADC) unit, down-converting the digital signal at a digital front end unit, converting the down-converted signal from a time domain to a frequency domain at a fast Fourier transform (FFT) unit, removing a cyclic prefix (CP) from the signal converted to the frequency domain at a CP unit, converting the signal from which the CP has been removed into a form that is capable of being transmitted at a photonic integrated chip (PIC) at a framer, and transferring the converted signal to a signal processing unit at the PIC.

According to the disclosure, power consumption of an MMU device is minimized.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an example of a wireless communication system according to an embodiment of the disclosure;

FIG. 1B illustrates an example if a fronthaul interface according to an embodiment of the disclosure;

FIG. 2 is a diagram illustrating an example of low layer function split through a radio unit or remote unit (RU) and a digital unit or distributed unit (DU) according to an embodiment of the disclosure;

FIGS. 3 and 4 are diagrams illustrating an example of a massive multiple-input multiple-output (MIMO) unit (MMU) structure according to various embodiments of the disclosure;

FIG. 5 is a diagram illustrating an example of a radio frequency integrated circuit (RFIC) structure according to an embodiment of the disclosure;

FIG. 6 is a diagram illustrating an MMU structure according to an embodiment of the disclosure;

FIG. 7 is a diagram illustrating an RFIC structure according to an embodiment of the disclosure;

FIG. 8 is a diagram illustrating an RFIC structure according to an embodiment of the disclosure;

FIG. 9 is a diagram illustrating an RFIC structure according to an embodiment of the disclosure; and

FIG. 10 is a flowchart illustrating an RFIC operating method according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a next generation Node B (gNode B), an evolved Node B (eNode B), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station and the terminal are not limited to the above examples. In the disclosure, a “downlink (DL)” refers to a radio link via which a base station transmits a signal to a terminal, and an “uplink (UL)” refers to a radio link via which a terminal transmits a signal to a base station.

To meet the demand for wireless data traffic, 5^{th} generation communication systems have been commercialized, providing users with high data transmission rate services through 5G systems, similar to 4th generation (4G) systems. Furthermore, it is anticipated that wireless communication services for various purposes, such as the Internet of things and services requiring high reliability for specific applications, can be provided.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

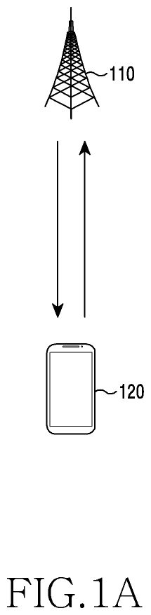

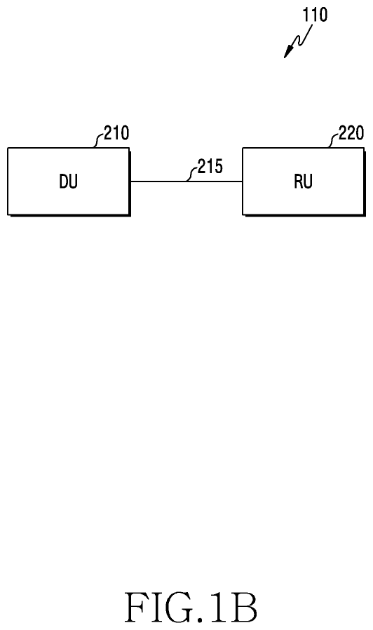

FIG. 1A illustrates an example of a wireless communication system according to an embodiment of the disclosure.

FIG. 1A illustrates a base station 110 and a UE 120 as some of nodes using a radio channel in the wireless communication system. Although FIG. 1A illustrates only one base station, the wireless communication system may further include other base stations identical or similar to the base station 110.

Referring to FIG. 1A, the base station 110 is a network infrastructure that provides the UE 120 with radio access. The base station 110 has coverage defined based on a distance over which the base station 110 can transmit a signal. The base station 110 may be referred to as an access point (AP), an eNodeB (eNB), a 5th-generation (5G) node, a next-generation nodeB (gNB), a wireless point, a transmission/reception point (TRP), or other terms having equivalent technical meanings, in addition to a base station.

The UE 120 is a device used by a user and performs communication with the base station 110 through a radio channel. A link from the base station 110 toward the UE 120 is referred to as a downlink (DL), and a link from the UE 120 toward the base station 110 is referred to as an uplink (UL). In addition, although not illustrated in FIG. 1A, the UE 120 may perform communication with each other through a radio channel. A link between the UE 120 and another UE (device-to-device (D2D) link) is referred to as a sidelink, which may be used interchangeably with “PC5 interface”. In some other embodiments, the UE 120 may be operated without a users' involvement. According to an embodiment, the UE 120 is a device that performs machine type communication (MTC), and may not be carried by a user. In addition, according to an embodiment, the UE 120 may be a narrowband (NB)-Internet of things (IoT) device.

The UE 120 may be referred to as a terminal, a customer premises equipment (CPE), a mobile station, a subscriber station, a remote terminal, a wireless terminal, an electronic device, a user device, or other terms having equivalent technical meanings, in addition to a user equipment (UE).

Conventionally, in a communication system including base stations with a relatively large cell radius, each base station is installed to include functions of a digital processing unit (or distributed unit (DU)) and a radio frequency (RF) processing unit (or radio unit (RU)). However, as 4th generation (4G) and/or beyond 4G (e.g., 5G) communication systems use higher frequency bands and have smaller and smaller cell coverage, the number of base stations for covering a specific areas has increased. Providers have been burdened with increased costs for installing the base stations. In order to minimize the costs for installing base stations, a structure has been proposed in which the DU and RU of a base station are split such that one or more RUs are connected to one DU through a wired network and one or more RUs distributed geographically are deployed to cover a specific area. Hereinafter, examples of the deployment structure and extension of a base station according to various embodiments of the disclosure will be described with reference to FIG. 1B.

FIG. 1B illustrates an example of a fronthaul interface according to an embodiment of the disclosure.

The fronthaul refers to a part between entities between a wireless local area network (LAN) and a base station, unlike a backhaul between a base station and a core network. Although FIG. 1B illustrates an example of a fronthaul structure between a DU 210 and one RU 220, this is only for the sake of descriptive convenience, and the disclosure is not limited thereto. In other words, embodiments of the disclosure may also be applied to a fronthaul structure between one DU and multiple RUs. For example, embodiments of the disclosure may be applied to a fronthaul structure between one DU and two RUs. In addition, embodiments of the disclosure may be applied to a fronthaul structure between one DU and three RUs.

Referring to FIG. 1B, the base station 110 may include a DU 210 and an RU 220. The fronthaul 215 between the DU 210 and the RU 220 may be operated through an Fx interface. For example, an interface such as an enhanced common public radio interface (eCPRI) or radio over ethernet (ROE) may be used to operate the fronthaul 215.

Mobile data traffic has increased in line with developing communication technologies, and accordingly, the amount of bandwidths required in the fronthaul between a digital unit and a radio unit has significantly increased. In a deployment such as a centralized/cloud radio access network (C-RAN), the DU may be implemented to perform functions for the packet data convergence protocol (PDCP), radio link control (RLC), media access control (MAC), and physical (PHY), and the RU may be implemented to further perform the functions for the PHY layer, in addition to the radio frequency (RF) functions.

The DU 210 may handle upper layer functions of a radio network. For example, the DU 210 may perform the MAC layer functions and a part of the PHY layer. As used herein, a part of the PHY layer refers to functions performed in upper steps among the PHY layer functions, and may include, for example, channel encoding (or channel decoding), scrambling (or descrambling), modulation (or demodulation), and layer mapping (or layer demapping). According to an embodiment, the DU 210 may be referred to as an O-DU (O-RAN DU) when following O-RAN specifications. In embodiments of the disclosure, the DU 210 may also be replaced with and referred to as a first network entity for a base station (e.g., gNB), if necessary.

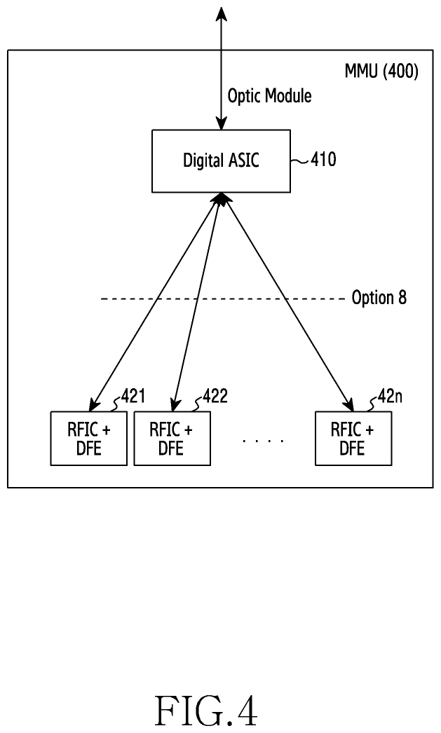

The RU 220 may handle lower layer functions of a radio network. For example, the RU 220 may perform the RF functions and a part of the PHY layer. As used herein, a part of the PHY layer refers to functions performed in relatively lower steps than the DU 210 among the PHY layer functions, and may include, for example, IFFT transform (or FFT transform), CP insertion (CP removal), and digital beamforming. An example of such split of specific functions will be described in detail with reference to FIG. 4. The RU 220 may be referred to as an access unit (AU), an access point (AP), a transmission/reception point (TRP), a remote radio head (RRH), a radio unit (RU), or other terms having equivalent technical meanings. According to an embodiment, the RU 220 may be referred to as an O-RU (O-RAN RU) when following O-RAN specifications. In embodiments of the disclosure, the RU 220 may be replaced with and referred to as a second network entity for a base station (e.g., gNB), if necessary.

Although it is assumed in FIG. 1B that the base station includes the DU 210 and the RU 220, embodiments of the disclosure are not limited thereto. According to embodiments, the base station may be implemented in a distributed deployment based on a centralized unit (CU) that performs functions of upper layers (e.g., packet data convergence protocol (PDCP) and radio resource control (RRC)) and a distributed unit (DU) that performs functions of lower layers of an access network. The distributed unit (DU) may include the digital unit (DU) and the radio unit (RU) in FIG. 1B. The base station may be implemented in a structure in which the CU, DU, and RU are deployed in that order between a core (e.g., 5G core (5GC) or next generation core (NGC)) network and a radio access network (RAN). The interface between the CU and the distributed unit (DU) may be referred to as an F1 interface.

The centralized unit (CU) may be connected to one or more DUs so as to handle functions of upper layers than the DUs. For example, the CU may handle functions of the radio resource control (RRC) and packet data convergence protocol (PDCP) layers, and the DU and RU may handle functions of lower layers. The DU may perform some functions of the radio link control (RLC) and media access control (MAC) layers and some functions (high PHY) of the physical (PHY) layer, and the RU may handle the other functions (low PHY) of the PHY layer. In addition, as an example, the digital unit (DU) may be included in the distributed unit (DU) as the base station is implemented in a distributed deployment. In the following, although operations of the digital unit (DU) and operations of the RU will be described unless defined otherwise, various embodiments of the disclosure may also be applied to both a base station deployment including the CU and a deployment in which the DU is connected directly to the core network (i.e., a base station (e.g., NG-RAN node) implemented such that the CU and the DU are incorporated into a single entity).

Business operators and equipment providers gathered and established Open Radio Access Network Alliance (O-RAN) to define new network element (NE) and interface specifications, based on 3GPP specifications, thereby presenting an Open Radio Access Network (O-RAN) structure. The O-RAN newly defined that the radio unit (RU), the distributed unit (DU), the central unit-control plane (CU-CP), and the central unit-user plane (CU-UP), which are legacy 3GPP NEs, are an O-RAN radio unit (O-RU), an O-RAN distributed unit (O-DU), and an O-RAN-control unit-control plane (O-CU-CP), and an O-RAN-control unit-user plane (O-CU-UP), respectively (they may be referred to as an O-RAN base station as a whole). The O-DU is a logical node including functions other than functions exclusively allocated to the O-RU, among functions of the base station (e.g., eNB, gNB). The O-DU may control the operation of the O-RU. The O-DU may communicate with the O-RU through a lower layer spit (LLS) interface. The LLS interface may correspond to a fronthaul interface. The LLS interface may refer to a logical interface between the O-DU and the O-RU, which uses a lower layer functional split (that is, intra-PHY-based functional split).

Although each logical node is illustrated in FIGS. 1A and 1B as a single entity, each logical node may be connected by multiple entities. As an example, multiple O-RUs may be connected to one O-DU, and multiple O-DUs may be connected to one O-CU-UP.

The disclosure is not limited by aforementioned names of respective nodes, and in the case of logical nodes or entities that perform aforementioned functions, configurations according to an embodiment of the disclosure may be applied. In addition, logical nodes may be located in physically identical or different positions, and functions thereof may be provided by the same physical device (for example, processor, controller, or the like) or by different physical devices. As an example, a single physical device may provide at least one of the aforementioned logical node functions through virtualization. Hereinafter, “O-DU” may be used interchangeably with “DU,” and “O-RU” may be used interchangeably with “RU.”

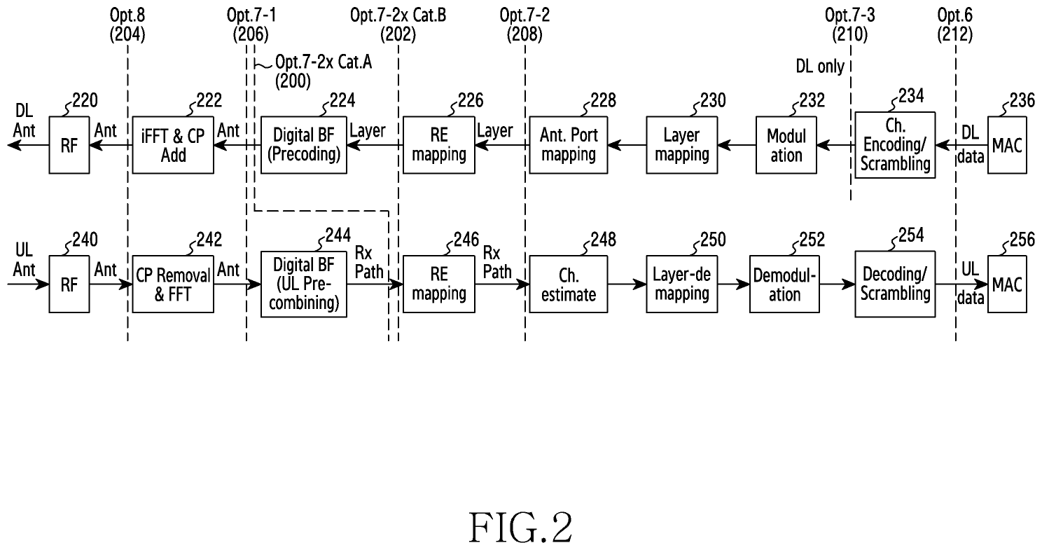

FIG. 2 is a diagram illustrating an example of low layer function split through a radio unit or remote unit (RU) and a digital unit or distributed unit (DU) according to an embodiment of the disclosure.

With the advancement of mobile communication technology, the frequency band in use has expanded, and it has become possible to provide mobile communication services, particularly in the ultrahigh-frequency band. In the ultrahigh-frequency band, the cell radius of a base station becomes smaller due to frequency characteristics, which has led to the need for a greater number of radio units or remote units (RU). In addition, as the amount of data transmitted in mobile communication systems has increased, the volume of data transmitted through the fronthaul interface has also significantly risen. Consequently, the cost of building wired networks in mobile communication systems has increased as well. Therefore, in order to reduce the transmission bandwidth of the fronthaul and to lower the construction cost of wired networks, a “function split” may be utilized, which involves assigning some functions of the digital unit or distributed unit (DU) to the RU. More specifically, the RU and the DU may divide and perform the functions of the physical layer.

In order to reduce the burden on the DU, the role of the RU, which traditionally handled only RF functions, may be expanded to include some functions of the physical layer. As the RU performs upper-layer functions, there are advantages in that the RU's throughput increases, the fronthaul transmission bandwidth can be reduced, and the requirements for response processing delay time are lowered. However, as the RU takes on upper-layer functions, there are disadvantages in that the virtualization gain decreases, and the size, weight, and manufacturing cost of the RU increase. Therefore, considering the trade-off between the aforementioned advantages and disadvantages, implementing an optimal function split is required.

Referring to FIG. 2, function splits in the physical layer are illustrated.

In the case of the downlink (DL), the physical layer receives downlink data from the MAC layer 236, and channel coding and scrambling regarding the received data are performed (234). The scrambled data is modulated (232), and modulated symbols are subjected to layer mapping (230). Modulated symbols mapped to respective layers are mapped to respective antenna ports (228), are mapped to the corresponding resource element (RE, an allocation unit of a resource configured by one subcarrier and one symbol) (226), and are subjected to digital beamforming (e.g., precoding) (224). Thereafter, the frequency-domain signal undergoes an Inverse Fast Fourier Transform (IFFT) and is transformed into a time-domain signal. A cyclic prefix (CP) is added to the signal (222), and the RU 220 loads the signal onto a carrier frequency, which is transmitted to the UE through the antenna.

In addition, in the case of the uplink (UL), the physical layer converts the signal of the carrier frequency received through an antenna into a baseband signal at the RF 240, and the converted signal is transformed into a frequency-domain signal through CP removal and FFT (242). Thereafter, the applied digital beamforming is reversed to combine the uplink signal 244, and the signal is demapped from the RE to which the uplink signal has been mapped (246), thereby performing channel estimation (248). Subsequently, layer demapping is performed (250) to demodulate the aligned modulation symbol (252), and the bit sequence acquired as a result of demodulation is descrambled and decoded to acquire information bits (254). The information bits are then transmitted to the MAC layer 256.

Such a low layer function split includes various options, and FIG. 2 illustrates examples such as option 6 212, option 7-3 210, option 7-2 208, option 7-2x category B 202, option 7-2x category A 200, option 7-1 206, and option 8 204. Functions located to the right of a given option are performed by the DU, and functions located to the left are performed by the RU.

For example, the CPRI of a long term evolution (LTE) system corresponds to option 8 204. In the case of the downlink, a signal with all processes of the physical layer performed by the DU is transmitted to the RU through the fronthaul interface, and the RU only performs the processing of converting the reception signal into an analog signal and transmitting the same to the UE. In addition, in option 7-1 206, the RU performs iFFT conversion/CP insertion in the DL of the PHY function and FFT conversion/CP removal in the UL, and the DU may perform the remaining PHY functions.

In the O-RAN, option 7-2x category B 202 and option 7-2x category A 200 may be supported. Option 7-2x category B 202 and option 7-2x category A 200 are distinguished according to whether the O-RU can perform precoding with regard to the data received from the O-DU.

In option 7-2x category B 202, the RU performs up to digital beamforming in both the DL and UL, and the DU performs upper PHY functions after digital beamforming. The O-RU is an O-RU that performs precoding on the data received from the O-DU and may be referred to as a category B O-RU.

In option 7-2x category A 200, the RU performs iFFT conversion/CP insertion in the DL of the PHY function and FFT conversion/CP removal and digital beamforming in the UL, while the DU handles the remaining PHY functions. The O-RU is an O-RU that does not process precoding with regard to the data received from the O-DU and may be referred to as a category A O-RU.

The O-DU must support a category A O-RU with regard to eight transmission streams or less. In other words, the O-DU may support precoding with regard to up to eight transmission streams. In case that option 7-2x category B 202 is applied, the O-DU transmits information regarding modulation symbols completed up to layer mapping, along with beamforming information, to the O-RU, and the O-RU converts the modulation symbols into analog signals by applying beamforming thereto, and transmits the same to the UE through the antenna.

In option 7-2x, the information to be transmitted from the O-DU to the O-RU may include information transmitted on the management-plane (M-plane), information transmitted on the synchronization-plane (S-plane), information transmitted on the control-plane (C-plane), information transmitted on the user-plane (U-plane), and the like.

The information transmitted on the M-plane is transmitted non-real-time in both DL and UL directions and serves as information for the initial setup or reset (or reconfiguration) between the O-DU and O-RU. The information transmitted on the S-plane is transmitted in real-time and is used to synchronize or align the timing between the O-DU and O-RU. The information transmitted on the C-plane is transmitted in real-time in the DL direction and is used by the O-DU to transmit scheduling and/or beamforming commands to the O-RU. The information transmitted on the U-plane is transmitted in real-time in both DL and UL directions and includes DL frequency-domain IQ data (including synchronization signal blocks (SSB) and reference signals). On the U-plane, UL frequency-domain IQ data (including reference signals such as sounding reference signals) and frequency-domain IQ data regarding the physical random access channel (PRACH) are transmitted. The aforementioned information or data may be used interchangeably with messages.

In option 7-2 208, the RU performs up to RE mapping (or RE demapping) in both DL and UL, and the DU performs upper PHY functions after RE mapping (or RE demapping). In option 7-3 210, the RU performs up to modulation (or demodulation) in both DL and UL, and the DU handles upper PHY functions after modulation (or demodulation). In option 6 212, the RU performs up to encoding/scrambling (or decoding/descrambling) in both DL and UL, and the DU performs upper PHY functions after modulation (or demodulation).

As used herein, “upper-PHY” refers to physical layer processing handled by the DU of the fronthaul interface. For example, the upper-PHY may include forward error correction (FEC) encoding/decoding, scrambling, and modulation/demodulation. In addition, “lower-PHY” refers to physical layer processing handled by the RU of the fronthaul interface. For example, the lower-PHY may include FFT/iFFT, digital beamforming, physical random access channel (PRACH) extraction, and filtering. However, the aforementioned criteria do not exclude embodiments through other function splits.

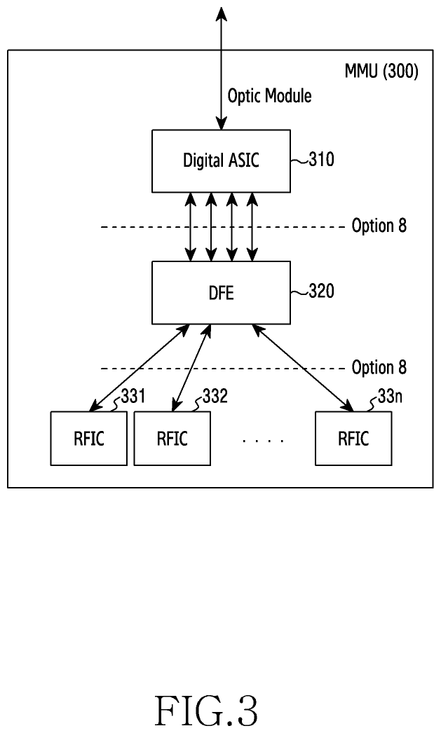

FIGS. 3 and 4 are diagrams illustrating an example of an MMU structure according to various embodiments of the disclosure.

FIGS. 3 and 4 represent an example of a general inter-chipset internal connection structure of a C-band MMU supporting a 5G 3.5 GHz carrier frequency.

Referring to FIG. 3, the massive multiple-input multiple-output (MIMO) unit (MMU) 300 may include a digital application specific integrated circuit (ASIC) 310, a digital front end (DFE) 320, and at least one or more radio frequency integrated circuits (RFIC) 331, 332, . . . , 33n. Respective components of the MMU 300, namely the digital ASIC 310, the digital front end 320, and at least one or more RFICs 331, 332, . . . , 33n, are connected by an interface for inter-chipset internal connection.

In addition, the digital ASIC 310, referring to FIG. 4, the MMU 400 may include a digital ASIC 410 and at least one or more RFICs 421, 422, . . . , 42n combined with a digital front end. Respective components of the MMU 400, namely the digital ASIC 410 and the RFICs 421, 422, . . . , 42n combined with a digital front end, are connected by an interface for inter-chipset internal connection.

Referring to FIG. 3, the digital front end 320 and at least one or more RFICs 331, 332, . . . , 33n may be configured as independent chips, respectively. Alternatively, referring to FIG. 4, the digital front end and the RFICs may be combined, thereby configuring RFICs 421, 422, . . . , 42n combined with a digital front end.

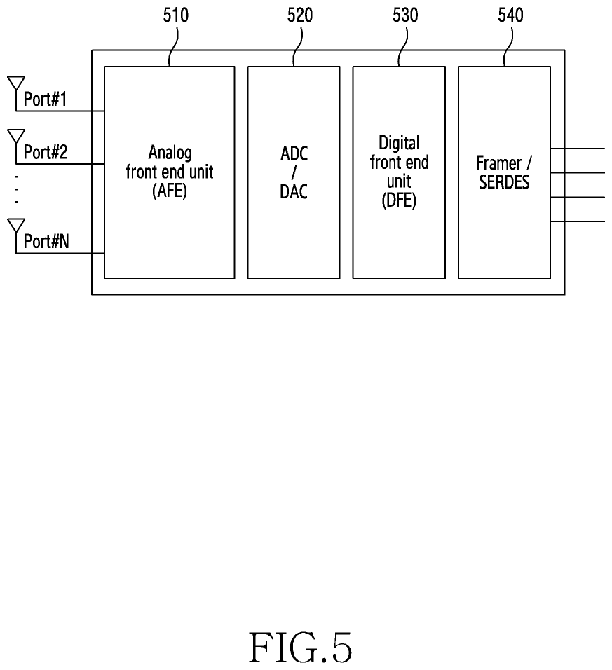

Referring to FIG. 5, the RFICs 331, 332, . . . , 33n and 421, 422, . . . , 42n included in the MMUs 300 and 400 will be described in more detail.

FIG. 5 is a diagram illustrating an example of a radio frequency integrated circuit (RFIC) structure according to an embodiment of the disclosure.

The RFIC may include an analog front end unit (AFE) 510, an analog-to-digital conversion (ADC)/digital-to-analog conversion (DAC) unit 520, a digital front end unit (DFE) 530, and a framer/serializer-deserializer (SerDes) 540. The RFIC in FIG. 5 may be the RFICs 421, 422, . . . , 42n combined with a digital front end, obtained by combining the digital front end and RFICs in FIG. 4. However, the RFIC in FIG. 5 is not limited thereto, may be the RFICs 331, 332, . . . , 33n in FIG. 3. The RFICs 331, 332, . . . , 33n in FIG. 3 include no digital front end 530.

The RFIC illustrated in FIG. 5 may transmit/receive radio frequency (RF) signals through the antenna, may perform sampling processing with the ADC/DAC to convert analog signals into digital signals, and may convert digital signals into analog signals. Furthermore, in case that a digital front end 530 is combined therewith as in FIG. 5, the digital front end 530 may convert RF carrier signals into baseband signals or may load baseband signals onto carrier signals. As described above, the digital front end 530 may also be configured separately from the RFIC.

As illustrated in FIGS. 3 and 4, option 8 of the low layer function split is applied within the MMUs 300 and 400. As described above, option 8 involves a signal with all processes of the physical layer performed by the DU being transmitted to the RU through the fronthaul interface. In case that this is applied to the MMUs 300 and 400, and in case that option 8 of the low layer function split is applied within the MMUs 300 and 400, time-domain data is transmitted between the digital front end 320 or the RFICs 421, 422, . . . , 42n combined with a digital front end and the digital ASICs 310 and 410. That is, the data to be transmitted through the fronthaul interface is transmitted between the RFIC and the digital ASIC. The time-domain data may include time-domain sampling data. In addition, the frequency-domain data may include orthogonal frequency division multiplexing (OFDM) subcarriers.

In future 5G Beyond/6th generation (6G) wireless communication systems supporting higher frequencies, it is anticipated that the amount of data to be transmitted through the fronthaul interface will increase. Specifically, 5G Beyond/6G wireless communication systems aim to dramatically enhance the transmission speed per user equipment (UE) by supporting high-frequency bands such as 6.5 GHZ, 13 GHZ, and 39 GHz and introducing extreme multiple input multiple output (MIMO) technology with an expanded number of ports and layers. The extreme MIMO technology targets support for 128 to 1024 transmission/reception (TRX) antenna ports and 32 to 256 layers. Therefore, under the MMU 300 and 400 structures illustrated in FIGS. 3 and 4, there is a need to increase the inter-chipset internal connection bandwidth (BW). More specifically, under the MMU 300 and 400 structures illustrated in FIGS. 3 and 4, the inter-chipset internal connection bandwidth is expected to require a data rate of 2 Tbps to 20 Tbps, an increase compared to the 259 Gbps of the existing C-band MMU.

In connection with the inter-chipset internal connection, the power consumption of the SerDes is expressed as twice the product of the interconnect data rate DR_{interconnect} and γ_{bit} (energy efficiency per bit).

$${P}_{interconnect} = 2 * D {R}_{interconnect} * {γ}_{bit} \qquad Equation 1$$

In Equation 1, the multiplication factor of 2 is applied by considering each SerDes for TX/RX. In addition, γ_{bit} is a constant value that is fixed according to each SerDes technology type.

Referring to Equation 1, if the existing data rate of 259 Gbps increases to 8.3 Tbps, the power consumption will rise by 32 times. Assuming the currently used SerDes has γ_{bit}, an energy efficiency of 10.5 pJ/bit, the existing power consumption of 5.4 Watts could increase to 174 Watts.

As such, according to the MMU 300 and 400 structures illustrated in FIGS. 3 and 4, as the inter-chipset internal connection BW increases, the power consumption also rises significantly. Therefore, there is a need for an RFIC structure that can minimize power consumption. Embodiments of the disclosure describe an RFIC structure capable of minimizing power consumption in wireless communication systems supporting higher frequencies.

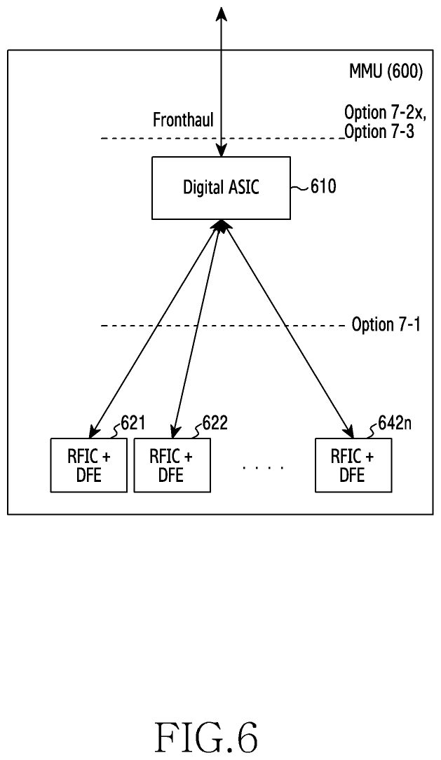

FIG. 6 is a diagram illustrating an MMU structure according to an embodiment of the disclosure.

Referring to FIG. 6, the MMU 600 may include a digital ASIC 610 and at least one or more radio frequency integrated circuits (RFICs) 621, 622, . . . , 62n combined with a digital front end. Respective components of the MMU 600, namely the digital ASIC 610 and at least one or more RFICs 621, 622, . . . , 62n combined with a digital front end, are connected through an interface for inter-chipset internal connection.

In addition, without being limited thereto, although not illustrated in FIG. 6, the MMU 630 may further include a power supply (not illustrated), a processor configured to control overall operations of the MMU 600, memory, and at least one or more antennas configured to transmit/receive RF signals. The antenna may include at least one or more antenna elements. Furthermore, in addition to the aforementioned components, other additional components may be further included.

The digital ASIC 610 processes radio signals (that is, RF signals) transmitted/received by the MMU 600. In an embodiment of the disclosure, the digital ASIC 610 may process digital signals according to low-physical (PHY) layer functions and may perform beamforming. More specifically, the digital ASIC 610 may process digital signals according to the 5G PHY layer standard.

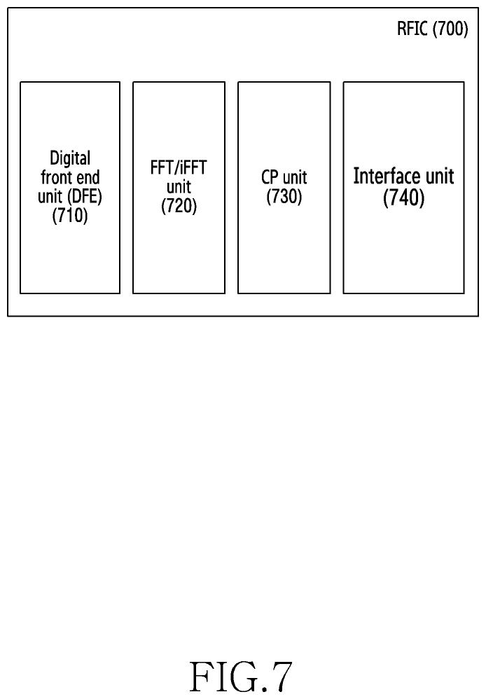

At least one or more RFICs 621, 622, . . . , 62n combined with a digital front end are RFICs that include functions of a digital front end. Referring to FIG. 7 to FIG. 9, the RFICs 621, 622, . . . , 62n included in the MMU 600 will be described in more detail.

FIG. 7 is a diagram illustrating an RFIC structure according to an embodiment of the disclosure.

Referring to FIG. 7, the RFIC 700 according to an embodiment of the disclosure may include a digital front end unit 710, a fast Fourier transform (FFT)/inverse FFT (iFFT) unit 720, a CP unit 730, and an interface unit 740. In addition, without being limited thereto, although not illustrated in FIG. 7, the RFIC 700 may further include other components, for example, an analog front end unit, an analog-to-digital/digital-to-analog (ADC/DAC) unit, and the like.

The digital front end unit 710 up-converts transmission signals and down-converts reception signals. In an embodiment, the digital front end unit 710 may receive a transmission signal processed with the iFFT from the FFT/iFFT unit 720, may up-convert the transmission signal, and may transfer the same to another component (for example, a digital-to-analog conversion (DAC) unit). In addition, the digital front end unit 710 may receive a reception signal from another component (for example, an analog-to-digital conversion (ADC) unit), may down-convert the reception signal, and may transmit the same to the FFT/iFFT unit 720.

The FFT/iFFT unit 720 converts a transmission signal from a frequency domain to a time domain and converts a reception signal from a time domain to a frequency domain. In an embodiment, the FFT/iFFT unit 720 may receive a transmission signal from the CP unit 730, may process the transmission signal with the iFFT to convert the same from a frequency domain to a time domain. The signal converted to the time domain may be transferred to the digital front end unit 710. In addition, the FFT/iFFT unit 720 may receive a reception signal from the digital front end unit 710, and may process the reception signal with the FFT to convert the same from a time domain to a frequency domain. The same may compress a 16-bit quantized in-phase/quadrature (I/Q) signal into frequency domain I/Q data having a 9-bit block floating point (BFP) format. According to an embodiment, this process may reduce the data size to 9/16, thereby decreasing the inter-chipset internal connection bandwidth. Accordingly, power consumption in the MMU 600 may be reduced. The signal converted to the frequency domain may be transferred to the CP unit 730.

The CP unit 730 adds a cyclic prefix (CP) to a transmission signal and removes a CP from a reception signal. In an embodiment, the CP unit 730 may receive a transmission signal from the interface unit 740, may add a CP thereto, and may transfer the same to the FFT/iFFT unit 720. The CP unit 730 may remove the CP from a reception signal transferred from the FFT/IFFT unit 720 and may transfer the same to the interface unit 740.

Although the FFT/iFFT unit 720 and the CP unit 730 are illustrated as separate functional blocks in the disclosure, the FFT/iFFT unit 720 and the CP unit 730 may be included in a single functional block. For example, the FFT/IFFT unit 720 and the CP unit 730 may operate within a single module.

The interface unit 740 performs communication with a signal processing unit. The signal processing unit may process a digital signal according to low-physical (PHY) layer functions and may perform beamforming. The signal processing unit may include a chip or a chipset and may include a digital application specific integrated circuit (ASIC).

In an embodiment, the interface unit 740 may include an optical input/output (I/O) device. The optical I/O device may include a photonic integrated chip (PIC), and the interface unit 740 may further include an electronic integrated circuit (EIC) to drive the PIC and a framer configured to convert a processed signal into a form that can be transmitted at the PIC and convert a signal received at the PIC into a processable form.

In addition, in an embodiment, the interface unit 740 may include a serializer-deserializer (SerDes) configured to convert a signal processed by the RFIC 700 into a form that can be transmitted at an interface and a framer configured to convert a signal received at the interface into a form that can be processed by the RFIC 700. The SerDes may include a high-speed pulse amplitude modulation 4-level (PAM-4) based SerDes.

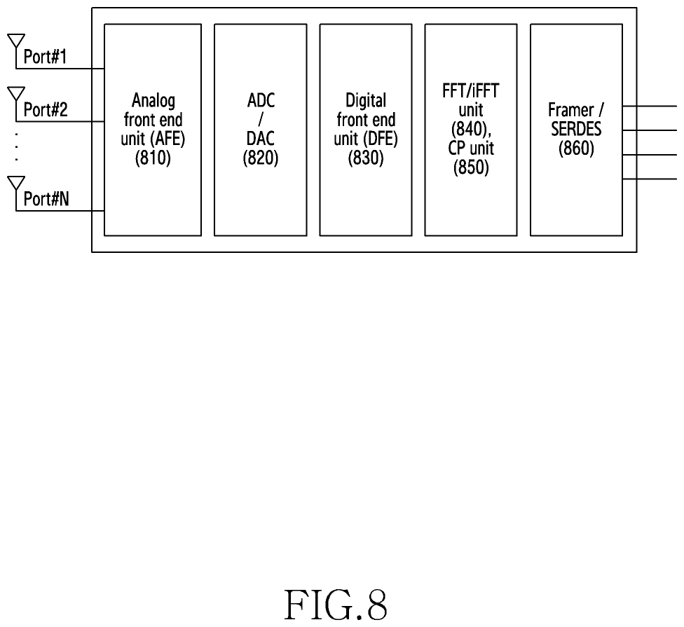

FIG. 8 is a diagram illustrating an RFIC structure according to another embodiment of the disclosure.

Referring to FIG. 8, the RFIC 800 may include an analog front end unit 810, an ADC/DAC unit 820, a digital front end unit 830, an FFT/iFFT unit 840, a CP unit 850, and a framer/SerDes 860. The digital front end unit 830, the FFT/iFFT unit 840, and the CP unit 850 may perform the same functions as the digital front end unit 710, the FFT/iFFT unit 720, and the CP unit 730 in FIG. 7.

The analog front end unit 810 amplifies a transmission signal and a reception signal. According to an embodiment, the analog front end unit 810 may receive an analog signal from the DAC of the ADC/DAC unit 820 and may amplify the same. The amplified signal may be transferred to at least one or more antennas. The analog front end unit 810 may receive a signal from at least one or more antennas and may amplify the same. More specifically, the same may amplify an RF signal received at each antenna port. The amplified signal may be transferred to the ADC/DAC unit 820.

The ADC/DAC unit 820 converts an analog signal to a digital signal through ADC processing and converts a digital signal to an analog signal through DAC processing. In an embodiment, the ADC/DAC unit 820 may convert an up-converted signal received from the digital front end unit 830 to an analog signal through DAC processing. The converted analog signal may be transferred to the analog front end unit 810. In connection with a signal converted through ADC processing, the ADC/DAC unit 820 may convert a down-converted signal received from the analog front end unit 810 to a digital signal. The converted digital signal may be transferred to the digital front end unit 830.

The digital front end unit 830 up-converts a transmission signal and down-converts a reception signal. In an embodiment, the digital front end unit 830 may receive a transmission signal processed with the iFFT from the FFT/iFFT unit 840, may up-convert the transmission signal, and may transfer the same to another component (for example, a digital-to-analog conversion (DAC) unit). In addition, the digital front end unit 830 may receive a reception signal from another component (for example, an analog-to-digital conversion (ADC) unit), may down-convert the reception signal, and may transfer the same to the FFT/IFFT unit 840.

The FFT/iFFT unit 840 converts a transmission signal from a frequency domain to a time domain and converts a reception signal from a time domain to a frequency domain. In an embodiment, the FFT/iFFT unit 840 may receive a transmission signal from the CP unit 850 and may process the transmission signal with the iFFT to convert the same from a frequency domain to a time domain. The signal converted to the time domain may be transferred to the digital front end unit 830. In addition, the FFT/iFFT unit 840 may receive a reception signal from the digital front end unit 830 and may process the reception signal with the FFT to convert the same from a time domain to a frequency domain. The same may compress a 16-bit quantized in-phase/quadrature (I/Q) signal into frequency domain I/Q data having a 9-bit block floating point (BFP) format. According to an embodiment, this process may reduce the data size to 9/16, thereby decreasing the inter-chipset internal connection bandwidth. Accordingly, power consumption in the MMU 600 may be reduced. The signal converted to the frequency domain may be transferred to the CP unit 850.

The CP unit 850 adds a cyclic prefix (CP) to a transmission signal and removes a CP from a reception signal. In an embodiment, the CP unit 850 may receive a transmission signal from the interface unit 740, may add a CP thereto, and may transfer the same to the FFT/iFFT unit 840. The CP unit 850 may remove the CP from a reception signal transferred from the FFT/IFFT unit 840 and may transfer the same to the interface unit 740.

Although the FFT/iFFT unit 840 and the CP unit 850 are illustrated as separate functional blocks in the disclosure, the FFT/iFFT unit 840 and the CP unit 850 may be included in a single functional block. For example, the FFT/iFFT unit 840 and the CP unit 850 may operate within a single module.

The framer/SerDes 860 performs communication with a signal processing unit. The signal processing unit may process a digital signal according to low-physical (PHY) layer functions and may perform beamforming. The signal processing unit may include a chip or a chipset and may include a digital application specific integrated circuit (ASIC).

In an embodiment, in the framer/SerDes 860, the SerDes may convert a signal processed by the RFIC 800 into a form that can be transmitted at an interface, and the framer may convert a signal received at the interface into a form that can be processed by the RFIC 800. In an embodiment, the SerDes 860 may process data using a time division multiplexing (TDM) type. The SerDes may include a high-speed PAM-4 based SerDes.

According to an embodiment, power may be saved by reducing the data size in the FFT/IFFT unit 840, and a cascade effect may be achieved by saving power in the time division multiplexing (TDM) type in the SerDes 860.

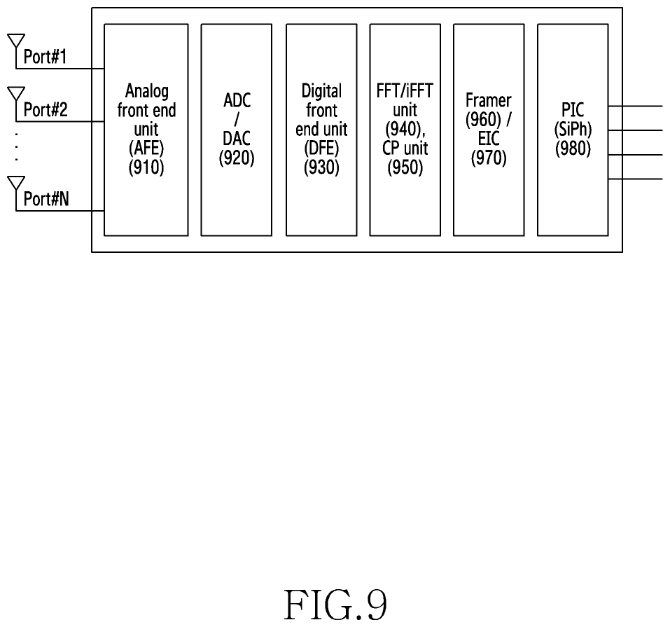

FIG. 9 is a diagram illustrating an RFIC structure according to another embodiment of the disclosure.

Referring to FIG. 9, the RFIC 900 may include an analog front end unit 910, an ADC/DAC unit 920, a digital front end unit 930, an FFT/iFFT unit 940, a CP unit 950, a framer 960, an electronic integrated circuit (EIC) 970, and a photonic integrated chip (PIC) 980. The digital front end unit 930, the FFT/iFFT unit 940, and the CP unit 950 may perform the same functions as the digital front end unit 710, the FFT/iFFT unit 720, and the CP unit 730 in FIG. 7, and the digital front end unit 830, the FFT/iFFT unit 840, and the CP unit 850 in FIG. 8.

The analog front end unit 910 amplifies a transmission signal and a reception signal. According to an embodiment, the analog front end unit 910 may receive an analog signal from the DAC of the ADC/DAC unit 920 and may amplify the same. The amplified signal may be transferred to at least one or more antennas. The analog front end unit 910 may receive a signal from at least one or more antennas and may amplify the same. More specifically, the same may amplify an RF signal received at each antenna port. The amplified signal may be transferred to the ADC/DAC unit 920.

The ADC/DAC unit 920 converts an analog signal to a digital signal through ADC processing and converts a digital signal to an analog signal through DAC processing. In an embodiment, the ADC/DAC unit 920 may convert an up-converted signal received from the digital front end unit 930 to an analog signal through DAC processing. The converted analog signal may be transferred to the analog front end unit 910. In connection with a signal converted through ADC processing, the ADC/DAC unit 920 may convert a down-converted signal received from the analog front end unit 910 to a digital signal. The converted digital signal may be transferred to the digital front end unit 930.

The digital front end unit 930 up-converts a transmission signal and down-converts a reception signal. In an embodiment, the digital front end unit 930 may receive a transmission signal processed with the FFT from the FFT/iFFT unit 940, may up-convert the transmission signal, and may transfer the same to another component (for example, a digital-to-analog conversion (DAC) unit). In addition, the digital front end unit 930 may receive a reception signal from another component (for example, an analog-to-digital conversion (ADC) unit), may down-convert the reception signal, and may transfer the same to the FFT/IFFT unit 940.

The FFT/iFFT unit 940 converts a transmission signal from a frequency domain to a time domain and converts a reception signal from a time domain to a frequency domain. In an embodiment, the FFT/iFFT unit 940 may receive a transmission signal from the CP unit 950 and may process the transmission signal with the iFFT to convert the same from a frequency domain to a time domain. The signal converted to the time domain may be transferred to the digital front end unit 930. In addition, the FFT/iFFT unit 940 may receive a reception signal from the digital front end unit 930 and may process the reception signal with the FFT to convert the same from a time domain to a frequency domain. The same may compress a 16-bit quantized in-phase/quadrature (I/Q) signal into frequency domain I/Q data having a 9-bit block floating point (BFP) format. According to an embodiment, this process may reduce the data size to 9/16, thereby decreasing the inter-chipset internal connection bandwidth. Accordingly, power consumption in the MMU 600 may be reduced. The signal converted to the frequency domain may be transferred to the CP unit 950.

The CP unit 950 adds a cyclic prefix (CP) to a transmission signal and removes a CP from a reception signal. In an embodiment, the CP unit 950 may receive a transmission signal from the interface unit 740, may add a CP thereto, and may transfer the same to the FFT/iFFT unit 940. The CP unit 950 may remove the CP from a reception signal transferred from the FFT/IFFT unit 940 and may transfer the same to the interface unit 740.

Although the FFT/iFFT unit 940 and the CP unit 950 are illustrated as separate functional blocks in the disclosure, the FFT/iFFT unit 940 and the CP unit 950 may be included in a single functional block. For example, the FFT/iFFT unit 940 and the CP unit 950 may operate within a single module.

The framer 960 may convert a signal processed by the RFIC 900 into a form that can be transmitted at the PIC 980 and may convert a signal received at the PIC 980 into a form that can be processed by the RFIC 900.

The EIC 970 drives the PIC 980.

The PIC 980 performs communication with a signal processing unit by using photons or light particles in connection with signals handled by the framer 960. That is, the same may perform optical communication. In an embodiment, the PIC 980 may include a silicon photonics PIC for optical input/output (I/O). The counterpart (for example, the signal processing unit) may also include a PIC to communicate with the PIC 980. In an embodiment, the PIC 980 may be integrated into the RFIC 900 in a 2D/2.5D/3D type through a chiplet interface. The silicon photonics PIC for optical I/O may operate with low power. For example, the silicon photonics PIC for optical I/O may operate at a power level of 1 pJ/bits. According to an embodiment, by including the PIC 980 that operates with low power, the RFIC 900 may reduce power consumption in the MMU 600.

According to an embodiment, power may be saved by reducing the data size in the FFT/iFFT unit 840, and a cascade effect may be achieved by using a PIC 980 that operates with low power.

Returning to the description of FIG. 6, low layer function split option 7-1 is applied within the MMU 600. In option 7-1, the RU may perform iFFT conversion/CP insertion in the DL of PHY functions and FFT conversion/CP removal in the UL, and the DU may perform the remaining PHY functions. In case that this is applied to the MMU 600, and in case that low layer function split option 7-1 is implemented within the MMU 600, frequency domain data, rather than time domain data, is transmitted between the RFICs 621, 622, . . . , 62n combined with a digital front end and the digital ASIC 610. That is, at least one or more radio frequency integrated circuits (RFICs) 621, 622, . . . , 62n combined with a digital front end include an iFFT/FFT unit such that conversion between the time domain and the frequency domain is performed by the RFICs. Accordingly, frequency domain data of a smaller size than time domain data may be transmitted between the RFICs 621, 622, . . . , 62n combined with a digital front end and the digital ASIC 610. The time domain data may include time domain sampling data. In addition, the frequency domain data may include orthogonal frequency division multiplexing (OFDM) subcarriers. According to an embodiment, by applying low layer function split option 7-1, the inter-chipset internal connection bandwidth may be reduced, thereby saving power.

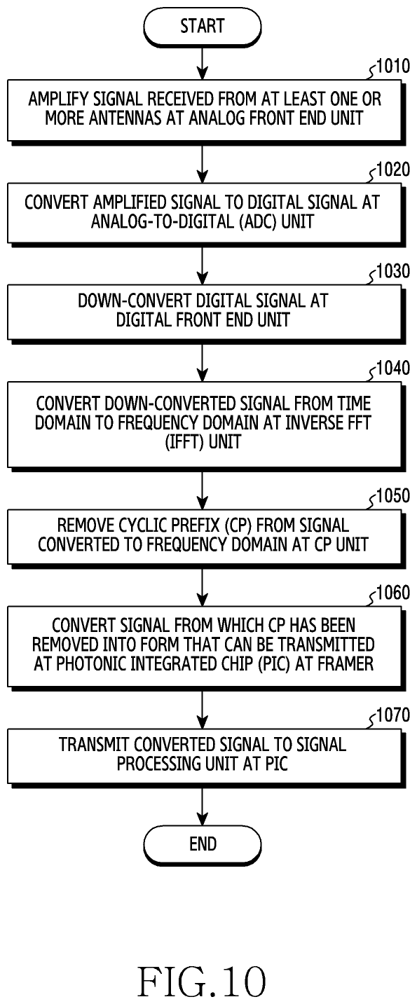

FIG. 10 is a flowchart illustrating an RFIC operating method according to an embodiment of the disclosure.

In operation 1010, the RFIC may amplify a signal received from at least one or more antennas at an analog front end unit.

In operation 1020, the RFIC may convert the amplified signal to a digital signal at an analog-to-digital conversion (ADC) unit.

In operation 1030, the RFIC may down-convert the digital signal at a digital front end unit.

In operation 1040, the RFIC may convert the down-converted signal from a time domain to a frequency domain at an FFT unit. The same may compress a 16-bit quantized in-phase/quadrature (I/Q) signal into frequency domain I/Q data having a 9-bit block floating point (BFP) format. According to an embodiment, this process may reduce the data size to 9/16, thereby decreasing the inter-chipset internal connection bandwidth. Accordingly, power consumption in the MMU 600 may be reduced. The signal converted to the frequency domain may be transferred to the CP unit 730.

In operation 1050, the RFIC may remove the cyclic prefix (CP) from the signal converted to the frequency domain at a CP unit.

In operation 1060, the RFIC may convert the signal from which the CP has been removed into a form that can be transmitted at a photonic integrated chip (PIC) at a framer.

Operation 1070 may include a step in which the RFIC transmits the converted signal to a signal processing unit at a PIC. The RFIC may save power consumed in the MMU through a SerDes that processes data in a time division multiplexing (TDM) type. In addition, the RFIC may include a PIC that operates with low power, thereby reducing power consumption in the MMU.

According to an embodiment, power may be saved by reducing the data size in the FFT/IFFT unit, and a cascade effect may be achieved through an interface unit that consumes low power.

Furthermore, the RFIC may receive a signal from the signal processing unit at the PIC and may convert the received signal into a processable form in the framer. In addition, the RFIC may add a CP to the converted signal at the CP unit, and may convert the signal having an added CP from a frequency domain to a time domain at the inverse FFT (iFFT) unit. Moreover, the time domain signal may be up-converted at the digital front end unit, and the up-converted signal may be converted to an analog signal at the digital-to-analog conversion (DAC) unit. Furthermore, the analog signal may be amplified at the analog front end unit and then transferred to at least one or more antennas.

A radio frequency integrated circuit (RFIC) according to an embodiment of the disclosure includes: a digital front end unit configured to up-convert a transmission signal and down-convert a reception signal; a fast Fourier transform (FFT)/inverse FFT (iFFT) unit configured to convert the transmission signal from a frequency domain to a time domain and convert the reception signal from a time domain to a frequency domain; a CP unit configured to add a cyclic prefix (CP) to the transmission signal and remove a CP from the reception signal; and an interface unit configured to perform communication with a signal processing unit.

In an embodiment, the interface unit may include an optical input/output (I/O) device.

In an embodiment, the optical I/O device may include a photonic integrated chip (PIC), and the interface unit may further include an electronic integrated circuit (EIC) for driving the PIC and a framer configured to convert a processed signal into a form that can be transmitted at the PIC and convert a signal received at the PIC into a processable form.

In an embodiment, the interface unit may include a serializer-deserializer (SerDes).

In an embodiment, the interface unit may include a framer configured to convert a processed signal into a form that can be transmitted at an interface and convert a signal received at the interface into a processable form.

In an embodiment, the signal processing unit may process a digital signal according to a low-physical (PHY) layer function and may perform beamforming.

In an embodiment, the signal processing unit may include a digital application specific integrated circuit (ASIC).

A massive multiple-input multiple-output (MIMO) unit (MMU) device according to an embodiment of the disclosure includes at least one or more antennas and at least one or more radio frequency integrated circuits (RFICs) connected to the at least one or more antennas. The at least one or more RFICs include: a digital front end unit configured to up-convert a transmission signal and down-convert a reception signal; a fast Fourier transform (FFT)/inverse FFT (iFFT) unit configured to convert the transmission signal from a frequency domain to a time domain and convert the reception signal from a time domain to a frequency domain; a CP unit configured to add a cyclic prefix (CP) to the transmission signal and remove a CP from the reception signal; and an interface unit configured to perform communication with a signal processing unit.

In an embodiment, the interface unit may include an optical input/output (I/O) device.

In an embodiment, the optical I/O device may include a photonic integrated chip (PIC), and the interface unit may further include an electronic integrated circuit (EIC) for driving the PIC and a framer configured to convert a processed signal into a form that can be transmitted at the PIC and convert a signal received at the PIC into a processable form.

In an embodiment, the interface unit may include a serializer-deserializer (SerDes).

In an embodiment, the interface unit may include a framer configured to convert a processed signal into a form that can be transmitted at an interface and convert a signal received at the interface into a processable form.

In an embodiment, the signal processing unit may process a digital signal according to a low-physical (PHY) layer function and may perform beamforming.

In an embodiment, the signal processing unit may include a digital application specific integrated circuit (ASIC).

A method for operating a radio frequency integrated circuit (RFIC) according to an embodiment of the disclosure includes: a step of amplifying a signal received from at least one or more antennas at an analog front end unit; a step of converting the amplified signal to a digital signal at an analog-to-digital conversion (ADC) unit; a step of down-converting the digital signal at a digital front end unit; a step of converting the down-converted signal from a time domain to a frequency domain at an FFT unit; a step of removing a cyclic prefix (CP) from the signal converted to the frequency domain at a CP unit; a step of converting the signal from which the CP has been removed into a form that can be transmitted at a photonic integrated chip (PIC) at a framer; and a step of transferring the converted signal to a signal processing unit at the PIC.

In an embodiment, the method for operating an RFIC may further include: a step of receiving a signal from the signal processing unit at the PIC; a step of converting the received signal into a processable form at the framer; a step of adding a CP to the converted signal at the CP unit; a step of converting the signal having the added CP from a frequency domain to a time domain at an inverse FFT (IFFT) unit; a step of up-converting the time domain signal at a digital front end unit; a step of converting the up-converted signal to an analog signal at a digital-to-analog conversion (DAC) unit; and a step of amplifying the analog signal at an analog front end unit and transferring the same to the at least one or more antennas.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A radio frequency integrated circuit (RFIC) comprising:
a digital front end unit configured to up-convert a transmission signal and down-convert a reception signal;
a fast fourier transform (FFT)/inverse FFT (iFFT) unit configured to convert the transmission signal from a frequency domain to a time domain and convert the reception signal from a time domain to a frequency domain;
a cyclic prefix (CP) unit configured to add a CP to the transmission signal and remove a CP from the reception signal; and
an interface unit configured to communicate with a signal processing unit.

2. The RFIC of claim 1, wherein the interface unit comprises an optical input/output (I/O) device.

3. The RFIC of claim 2,
wherein the optical I/O device comprises a photonic integrated chip (PIC), and
wherein the interface unit further comprises:
an electronic integrated circuit (EIC) for driving the PIC, and
a framer configured to convert a processed signal into a form that can be transmitted at the PIC and convert a signal received at the PIC into a processable form.

4. The RFIC of claim 1, wherein the interface unit comprises a serializer-deserializer (SerDes).

5. The RFIC of claim 4, wherein the interface unit comprises a framer configured to convert a processed signal into a form that can be transmitted at an interface and convert a signal received at the interface into a processable form.

6. The RFIC of claim 1, wherein the signal processing unit is configured to process a digital signal according to a low-physical (PHY) layer function and perform beamforming.

7. The RFIC of claim 1, wherein the signal processing unit comprises a digital application specific integrated circuit (ASIC).

8. A massive multiple-input multiple-output (MIMO) unit (MMU) device comprising:
at least one antenna; and
at least one radio frequency integrated circuit (RFIC) connected to the at least one antenna,
wherein the at least one RFIC comprises:
a digital front end unit configured to up-convert a transmission signal and down-convert a reception signal,
a fast fourier transform (FFT)/inverse FFT (iFFT) unit configured to convert the transmission signal from a frequency domain to a time domain and convert the reception signal from a time domain to a frequency domain,
a CP unit configured to add a cyclic prefix (CP) to the transmission signal and remove a CP from the reception signal, and
an interface unit configured to communicate with a signal processing unit.

9. The MMU device of claim 8, wherein the interface unit comprises an optical input/output (I/O) device.

10. The MMU device of claim 9,
wherein the optical I/O device comprises a photonic integrated chip (PIC), and
wherein the interface unit further comprises:
an electronic integrated circuit (EIC) for driving the PIC, and
a framer configured to convert a processed signal into a form that can be transmitted at the PIC and convert a signal received at the PIC into a processable form.

11. The MMU device of claim 8, wherein the interface unit comprises a serializer-deserializer (SerDes).

12. The MMU device of claim 11, wherein the interface unit comprises a framer configured to convert a processed signal into a form that can be transmitted at an interface and convert a signal received at the interface into a processable form.

13. The MMU device of claim 8, wherein the signal processing unit comprises a digital application specific integrated circuit (ASIC) and is configured to process a digital signal according to a low-physical (PHY) layer function and perform beamforming.

14. A method for operating a radio frequency integrated circuit (RFIC), the method comprising:
amplifying a signal received from at least one antenna at an analog front end unit;
converting the amplified signal to a digital signal at an analog-to-digital conversion (ADC) unit;
down-converting the digital signal at a digital front end unit;
converting the down-converted signal from a time domain to a frequency domain at a fast Fourier transform (FFT) unit;
removing a cyclic prefix (CP) from the signal converted to the frequency domain at a CP unit;
converting the signal from which the CP has been removed into a form that is capable of being transmitted at a photonic integrated chip (PIC) at a framer; and
transferring the converted signal to a signal processing unit at the PIC.

15. The method of claim 14, further comprising:
receiving a signal from the signal processing unit at the PIC;
converting the received signal into a processable form at the framer;
adding a CP to the converted signal at the CP unit;
converting the signal having the added CP from a frequency domain to a time domain at an inverse FFT (iFFT) unit;
up-converting the time domain signal at a digital front end unit;
converting the up-converted signal to an analog signal at a digital-to-analog conversion (DAC) unit; and
amplifying the analog signal at an analog front end unit and transferring the amplified analog signal to the at least one or more antennas.
